(19) United States
(12) Patent Application Publication
(10) Pub. No.: US 2013/0137546 A1
(43) Pub. Date: May 30, 2013

(54) ROTATION MECHANISM

(71) Applicant: CHENG-SHIUN WU, Tu-Cheng (TW)

(72) Inventor: CHENG-SHIUN WU, Tu-Cheng (TW)

(73) Assignee: HON HAI PRECISION INDUSTRY CO., LTD., Tu-Cheng (TW)

(21) Appl. No.: 13/398,528

(22) Filed: Feb. 16, 2012

(30) Foreign Application Priority Data
Nov. 29, 2011 (TW) 100143632

(51) Int. Cl. F16H 13/02

(52) U.S. Cl. 476/67

(57) ABSTRACT

A rotation mechanism includes a base, a loading member rotatably placed on the base, and a driving member rotatably placed on the base. The loading member includes a side surface. The driving member includes a main body. The main body of the driving member includes a side surface. The side surface of the loading member maintains contact with the side surface of the main body. When the driving member is rotated, the loading member is rotatably driven by the friction between the side surface of the loading member and the side surface of the main body. The driving member further includes a positioning portion placed on the main body, and after rotation through a predetermined number of degrees of the main body, the positioning portion positions the driving member accordingly.

### BACKGROUND

1. Technical Field

The present disclosure relates generally to rotation mechanisms, especially, to a rotation mechanism used for testing a camera module.

2. Description of Related Art

Three-dimensional (3D) camera module includes two lens units arranged in a particular alignment. During production of the camera module, resolutions of the two lens units need to be tested. After testing the resolution of one lens unit, the 3D camera module is rotated manually to place the other lens unit at a predetermined testing position. However, a work efficiency of such method is relatively low, and the 3D camera module is easy to be smeared or smudged. To improve the work efficiency, the 3D camera module can be placed on an automatic rotation mechanism, such as a rotation mechanism driven by a motor. However, because an automatic driving member of the automatic rotation mechanism causes vibration, this may negatively affect a precision of the 3D camera module.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of a first embodiment of a rotation mechanism.

FIG. 2 is an assembled, isometric view of a second embodiment of a rotation mechanism.

FIG. 3 is an assembled, isometric view of a third embodiment of a rotation mechanism.

### DETAILED DESCRIPTION

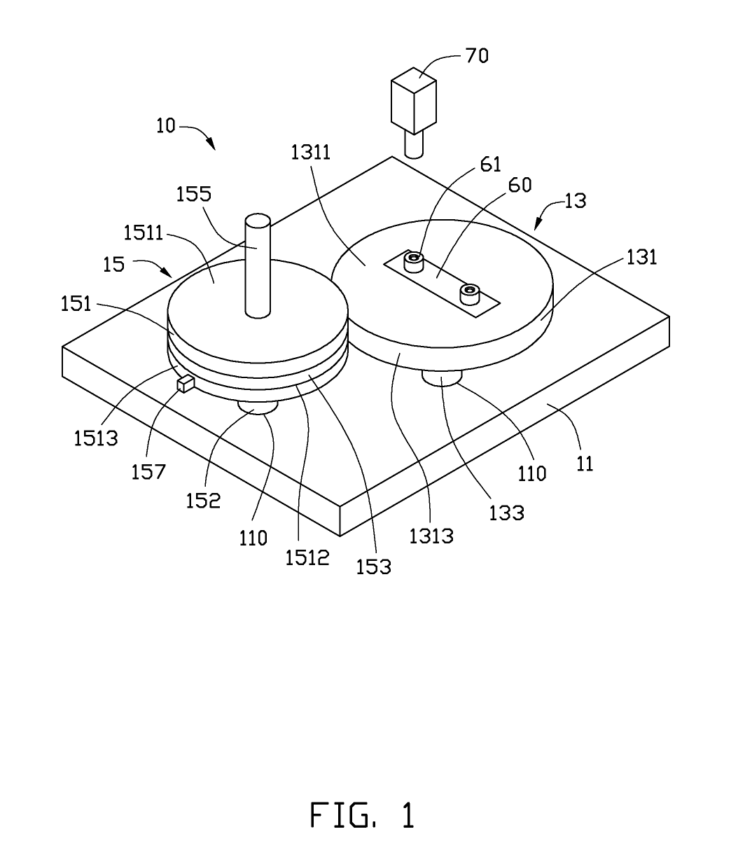

Referring to FIG. 1, a first embodiment of a rotation mechanism 10 is used to rotate a camera module 60 during testing of the camera module 60. The rotation mechanism 10 includes a base 11, a loading member 13 and a driving member 15. The camera module 60 is securely placed on the loading member 13 of the rotation mechanism 10, and includes two lens units 61 placed in a certain alignment on the loading member 13. In alternative embodiments, the rotation mechanism 10 can be used to rotate other articles during a testing or a production process of the other articles.

The base 11 is a substantially rectangular plate. Two mounting holes 110 are defined on the base 11.

The loading member 13 is rotatably mounted on the base 11. The loading member 13 includes a support seat 131 and a rotation shaft 133. The support seat 131 is substantially disc-like, and includes a support surface 1311 and a side surface 1313 connected to the support surface 1311. One end of the rotation shaft 133 is mounted in one mounting hole 110, and the other end of the rotation shaft 133 is securely connected to the support seat 131, such that the support seat 131 is rotatable around the rotation shaft 133.

The driving member 15 is rotatably mounted on the base 11, and maintains contact with the loading member 13. The driving member 15 includes a main body 151, a rotation shaft 152, a friction ring 153, a handle 155, and a positioning portion 157. The main body 151 is substantially a disc, and includes a mounting surface 1511 parallel to the support surface 1311 of the loading member 13 and a side surface 1513 connected to the mounting surface 1511. An annular groove 1512 is defined halfway down the side surface 1513. One end of the rotation shaft 152 is rotatably mounted in the other mounting hole 110, and the other end of the rotation shaft 152 is securely connected to the main body 151, such that the main body 151 is rotatable around the rotation shaft 152. The friction ring 153 is securely placed in the annular groove 1512. The friction ring 153 and the side surface 1513 make peripheral contact with the side surface 1313 of the loading member 13, such that when the main body 151 rotates, the support seat 131 rotates with the main body 151 as a result of friction therebetween. In the first embodiment, the friction ring 153 is made of rubber materials, for increasing the friction force between the friction ring 153 and the side surface 1313. In alternative embodiments, the friction ring 153 can be made of flax or flax-derived materials. The handle 155 is round and rod-like, and is securely mounted and placed in the central region of the mounting surface 1511. The positioning portion 157 is a substantially rectangular protrusion, and is placed on the side surface 1513 to position the main body 151 after rotation through a predetermined number of degrees. In the first embodiment, there is one positioning portion 157 included in the driving member 15. The positioning portion 157 limits the rotation of the main body 151 to 180 degrees. In alternative embodiments, a quantity of the positioning portion 157 can be changed as needed, such as to two or more, to achieve a different predetermined number of degrees of rotation.

In alternative embodiments, the friction ring 153 can be sleeved on the side surface 1313 of the support seat 131. The friction ring 153 is not absolutely necessary or considered essential element to have, in the case where a roughness of the side surface 1313 or the side surface 1513 is great or large enough to create sufficient friction between the support seat 131 and the main body 151 to drive the support seat 131 rotate relative to the main body 151.

When testing the camera module 60, the camera module 60 is placed on a central region of the support surface 1311 of the support seat 131, a testing equipment 70 is placed above one lens unit 61. After testing the one lens unit 61, the driving member 15 is rotated manually with the handle 155, and the support seat 131 rotates along with the driving member 151 because of friction therebetween. When the positioning portion 157 contacts or touches the support seat 131, the driving member 15 then stops, and the other lens unit 61 is placed on the predetermined position for performing testing.

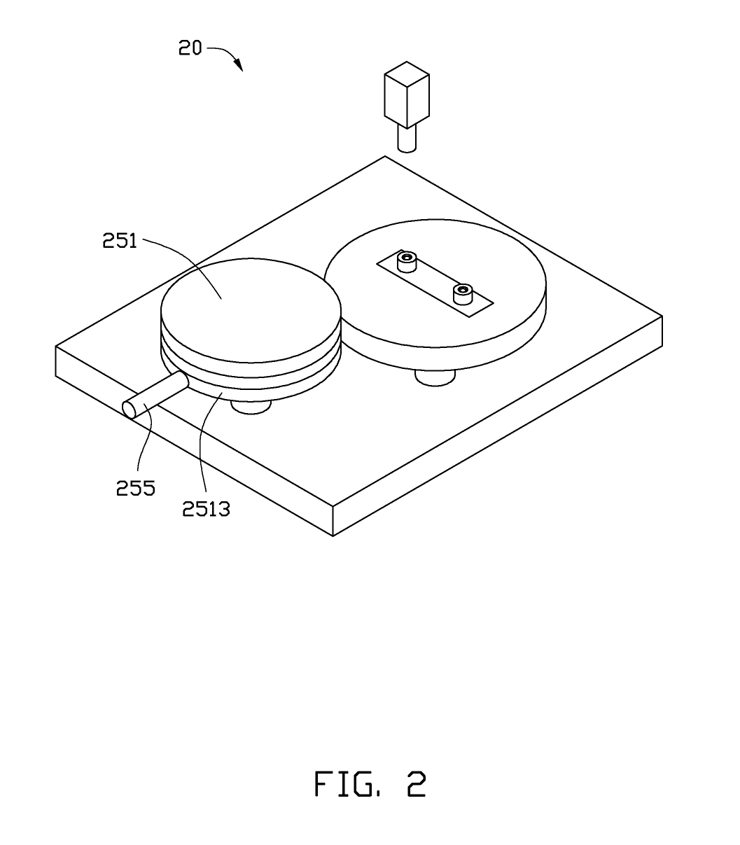

Referring to FIG. 2, a second embodiment of a rotation mechanism 20 having a similar structure to the first embodiment of the rotation mechanism 10 is shown. However, a handle 255 of the second embodiment is placed on a side surface 2513 of a main body 251, such that it is easy to rotate the main body 251, and also that a positioning portion is thereby omitted.

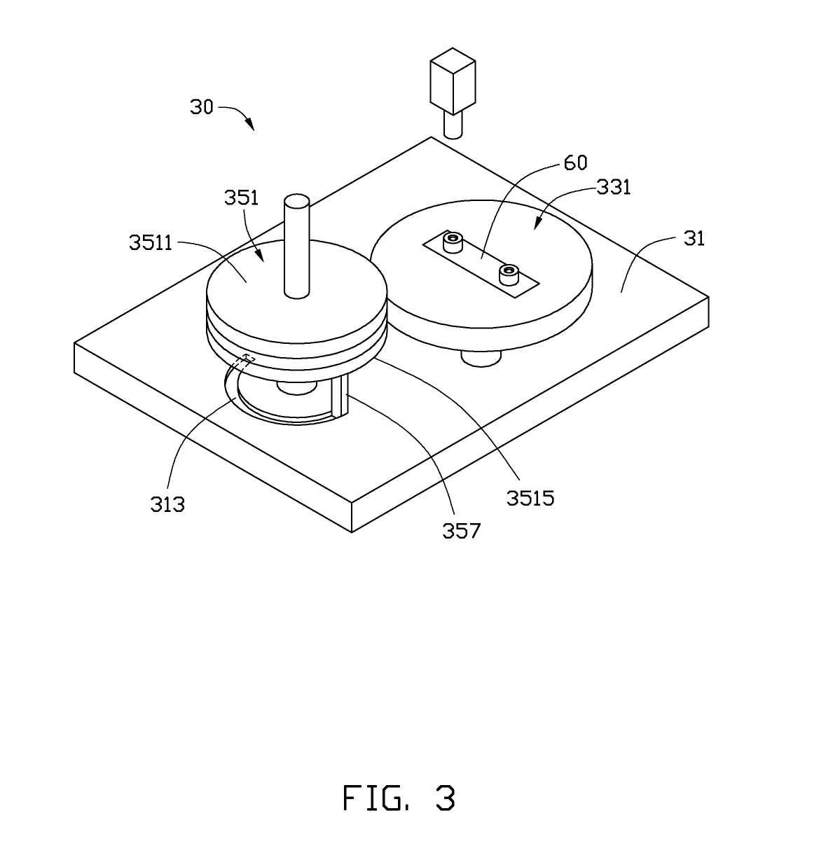

Referring to FIG. 3, a third embodiment of a rotation mechanism 30 similar to the first embodiment of the rotation mechanism 10 is shown. However, an arcuate positioning groove 313 is defined in a base 31 corresponding to a main body 351 in the third embodiment. A diameter of the positioning groove 313 is equal to that of the main body 351, and a center of the arc of the positioning groove 313 is on an axis of the main body 351. A positioning portion 357 is placed or mounted on a bottom surface 3515 opposite to a mounting surface 3511 of the main body 351, corresponding to the positioning groove 313. The positioning portion 357 is slidable in the positioning groove 313 to rotatably position the main body 351. During positioning of the lens units, contact with a support seat 331 is thereby avoided, such that the camera module 60 can be placed more stably on the support seat 331.

An automatic member is omitted in the various embodiments of the rotation mechanisms 10, 20, 30, so that vibration during rotation is reduced to be of the lowest possible order, so as to avoid negatively affecting a precision of the camera module 60. In addition, during operation, operators are prevented from contacting the camera module 60 directly, so the risk of smearing or smudging the camera module 60 is relatively low. Furthermore, the working efficiency of the rotation mechanisms 10, 20, 30 is higher, and the respective structures of the rotation mechanisms 10, 20, 30 are simpler with lower cost.

It is to be understood, however, that even through numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A rotation mechanism, comprising:
a base;
a loading member rotatably placed on the base, the loading member comprising a side surface; and
a driving member rotatably placed on the base, the driving member comprising a main body, the main body comprising a side surface, wherein the side surface of the loading member maintains contact with the side surface of the main body, when the driving member rotates, the loading member is rotatably driven by the friction between the side surface of the loading member and the side surface of the main body.

2. The rotation mechanism of claim 1, wherein the shape of the loading member and the main body is substantially a disc, respectively.

3. The rotation mechanism of claim 1, wherein the driving member further comprises a handle placed on the main body.

4. The rotation mechanism of claim 3, wherein the handle is placed on the side surface of the main body.

5. The rotation mechanism of claim 3, wherein the main body further comprises a mounting surface connected to the side surface of the main body, and the handle is placed on the mounting surface.

6. The rotation mechanism of claim 1, wherein the driving member further comprises a positioning portion placed on the side surface of the main body, and after rotation through a predetermined number of degrees of the main body, the positioning portion positions the driving member accordingly.

7. The rotation mechanism of claim 1, wherein a positioning groove is defined in one of the base and the main body, and a positioning portion engaged with the positioning groove is formed on the other one of the base and the main body, to rotatably position the main body.

8. A rotation mechanism, comprising:
a base;
a loading member rotatably placed on the base, the shape of the loading member being substantially a disc and comprising a side surface; and
a driving member rotatably placed on the base, the driving member comprising a main body, the shape of the main body being substantially a disc and comprising a side surface, wherein the side surface of the loading member maintains contact with the side surface of the main body, when the driving member rotates, the loading member is rotatably driven by the friction between the side surface of the loading member and the side surface of the main body.

9. The rotation mechanism of claim 8, wherein a handle is placed on the side surface of the main body.

10. The rotation mechanism of claim 8, wherein the main body further comprises a mounting surface connected to the side surface of the main body, and a handle is placed on the mounting surface.

11. The rotation mechanism of claim 8, wherein the driving member further comprises a positioning portion placed on the side surface of the main body, and after rotation through a predetermined number of degrees of the main body, the positioning portion positions the driving member accordingly.

12. The rotation mechanism of claim 8, wherein a positioning groove is defined in one of the base and the main body, and a positioning portion engaged with the positioning groove is formed on the other one of the base and the main body, to rotatably position the main body.

13. A rotation mechanism, comprising:
a base;
a loading member rotatably placed on the base, the loading member comprising a side surface; and
a driving member rotatably placed on the base, the driving member comprising a main body and a friction ring, the main body comprising a side surface, wherein an annular groove is defined in the side surface of the main body, the friction ring is placed in the annular groove, the side surface of the loading member maintains contacts with the friction ring, when the driving member rotates, the loading member is rotatably driven by the friction between the side surface of the loading member and the friction ring.

14. The rotation mechanism of claim 13, wherein the friction ring is made of rubber materials or flaxy materials.

15. The rotation mechanism of claim 13, wherein the driving member further comprises a positioning portion placed on the side surface of the main body, and after rotation through a predetermined number of degrees of the main body, the positioning portion positions the driving member accordingly.

16. The rotation mechanism of claim 13, wherein a positioning groove is defined in one of the base and the main body, and a positioning portion engaged with the positioning groove is formed on the other one of the base and the main body, to rotatably position the main body.

17. The rotation mechanism of claim 13, wherein the shape of the loading member and the main body is substantially a disc.

18. The rotation mechanism of claim 13, wherein the driving member further comprises a handle placed on the main body.

19. The rotation mechanism of claim 18, wherein the handle is placed on the side surface of the main body.

20. The rotation mechanism of claim 18, wherein the main body further comprises a mounting surface connected to the side surface of the main body, and the handle is placed on the mounting surface.
